(19) United States
(12) Patent Application Publication
(10) Pub. No.: US 2004/0193953 A1
(43) Pub. Date: Sep. 30, 2004

(54) Method, system, and program for maintaining application program configuration settings

(75) Inventors: Tony L. Callahan, Westminister, CO (US); Anthony J. Mullen, Broomfield, CO (US); Daniel J. Thomas, Boca Raton, FL (US)

Correspondence Address: FINNEGAN, HENDERSON, FARABOW, GARRETT & DUNNER, LLP, 1300 I STREET, NW, WASHINGTON, DC, 20005, US

(73) Assignee: Sun Microsystems, Inc.

(21) Appl. No.: 10/370,942

(22) Filed: Feb. 21, 2003

(51) Int. Cl. H02H 3/05

(52) U.S. Cl. 714/15

(57) ABSTRACT

Provided are a method, system, and program for maintaining configuration settings for applications on a computer system. Configuration backup information indicates configuration settings to backup for at least one of application. The configuration backup information is processed to access the indicated configuration settings for the at least one application on the computer system to backup and the accessed configuration settings for at least one application are stored in at least one file. The stored configuration settings are recovered for use with at least one application.

### BACKGROUND OF THE INVENTION

1. Field of the Invention

The present invention relates to a method, system, and program for maintaining application program configuration settings.

2. Description of the Related Art

Computer systems often include numerous installed computer programs, many of which are integrated and work together. Over time, the user will configure different settings for the installed programs so that the programs operate separately and together in a desired manner. Settings in one program can affect the operation of programs dependent on such program.

In the event of a disk or other non-recoverable system failure, the user may have to manually reinstall all the previously installed programs and then manually renter all the configuration settings for each program. If the user reenters the configuration settings from personal memory, then there is the risk that the user may not enter all previously set configuration settings or enter some incorrectly. Errors in configuring the reinstalled programs can affect the operation of the reinstalled programs and all programs that interact with that program.

There are two ways to save configuration settings. One is to use disk mirroring backup software that makes a complete backup of the entire computer system. This approach requires the use of a separate storage or backup device to store the mirror image of the computer. Further, operation of disk mirroring software requires taking the system offline to perform the backup, which can take a considerable amount of time. Still further, users or system administrators may forget to frequently perform disk mirroring to update the mirror copy. Failure to routinely perform the disk mirroring operation increases the risk that more recently entered configuration settings will not be recorded and available when reinstalling the programs.

Another approach for dealing with configuration settings is to separately record on paper or a document file information on all entered configuration settings. After reinstalling the software, the user or system administrator may then manually reenter the configuration settings as recorded. This approach is prone to user error when recording configuration settings on paper or in a document file and when reentering the configuration settings.

### SUMMARY OF THE DESCRIBED IMPLEMENTATIONS

Provided are a method, system, and program for maintaining configuration settings for applications on a computer system. Configuration backup information indicates configuration settings to backup for at least one application. The configuration backup information is processed to access the indicated configuration settings for the at least one application on the computer system to backup and the accessed configuration settings for the at least one application are stored in at least one file. The stored configuration settings are recovered for use with the at least one application.

In further implementations, user selection is received of the at least one application and at least one configuration setting for the selected at least one application to include in the configuration backup information.

Still further, the configuration backup information may indicate a backup location. In such implementations, the at least one file including the stored configurations settings is stored in the indicated backup location.

In yet further implementations, recovering the stored configuration settings may further involve receiving user selection of a subset of the stored configuration settings to recover, accessing the user selected subset of the stored configuration settings, and writing the selected subset of configuration settings to the computer to use with the applications associated with the configuration settings.

Described implementations provide techniques for maintaining and storing application configuration settings for use in the event such settings need to be recovered for use with the application programs for which configuration settings are maintained.

### BRIEF DESCRIPTION OF THE DRAWINGS

Referring now to the drawings in which like reference numbers represent corresponding parts throughout:

FIG. 1 illustrates a computing environment in accordance with implementations of the invention;

FIGS. 2, 3, and 4 illustrate data structures used to maintain configuration settings in accordance with implementations of his invention;

FIG. 5 illustrates operations performed to backup configuration settings in accordance with implementations of the invention;

FIG. 6 illustrates a graphical user interface (GUI) used to schedule a configuration backup operation in accordance with implementations of the invention;

FIG. 7 illustrates a graphical user interface (GUI) used to recover backed-up configuration settings in accordance with implementations of the invention;

FIG. 8 illustrates operations performed to recover backed-up configuration settings in accordance with implementations of the invention; and

FIG. 9 illustrates an architecture of computing devices that may be used with the described implementations.

### DETAILED DESCRIPTION

In the following description, reference is made to the accompanying drawings which form a part hereof and which illustrate several embodiments of the present invention. It is understood that other embodiments may be utilized and structural and operational changes may be made without departing from the scope of the present invention.

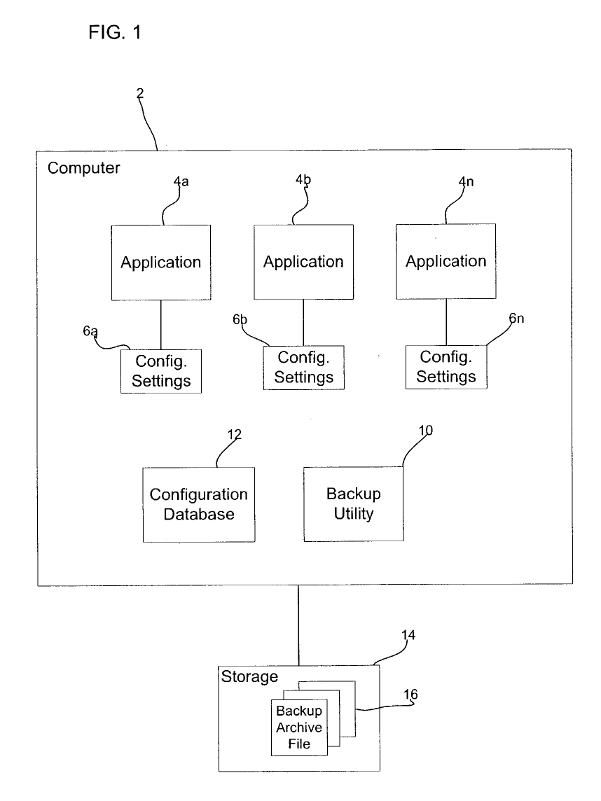

FIG. 1 illustrates a computing environment in which aspects of the invention are implemented. A computer 2 includes a plurality of installed application programs 4a, 4b . . . 4n each having associated configuration settings 6a, 6b . . . 6n providing configuration parameters used by the application 4a, 4b . . . 4n to configure the application 4a, 4b . . . 4n operation. The computer 2 may include any computing device known in the art, such as a desktop computer, workstation, laptop, server, mainframe, hand held computer, telephony device, network appliance, storage subsystem, etc. The application program 4a, 4b . . . 4n may comprise any application program known in the art. The configuration settings 6a, 6b . . . 6n for each application program 4a, 4b . . . 4n may be maintained in one or more data structures in the computer 2. For instance, in a Microsoft® Windows® operating system environment, the configuration settings 6a, 6b . . . 6n may be maintained in the registry file, initialization files (.ini), etc. In a Unix® operating system environment, the configuration settings 6a, 6b . . . 6n may be maintained in a binary file (.bin), text file (.txt), etc. (Microsoft and Windows are registered trademarks of Microsoft Corporation and Unix is a registered trademark of The Open Group) Moreover, the configuration settings 6a, 6b . . . 6n for one application 4a, 4b . . . 4n may be maintained in multiple data structures.

A backup utility 10 is a program that saves the configuration settings 6a, 6b . . . 6n, in accordance with the described implementations, for use in the event the user of the computer 2 has to reinstall the applications 4a, 4b . . . 4n. A “backup”, as that term is used herein, refers to any type of saving of data for later use or retrieval, such as recovery backup, archival, storage, etc. A configuration database 12 maintains information on the configuration settings 6a, 6b . . . 6n that the backup utility 10 stores. A storage 14 is coupled to the computer 2. The storage 14 may comprise any type of non-volatile storage device known in the art, including a removable storage medium, such as a CD-ROM, flash memory, external hard disk drive, disk, etc. Backed-up configuration settings are stored in one or more backup archive files 16, where each backup archive file 16 includes settings backed-up as part of one particular scheduled backup, which may involve backing-up configuration settings from different application programs. The backup archive file(s) 16 that store the configuration settings 6a, 6b . . . 6n from different applications 4a, 4b . . . 4n may comprise one or more files or other data structures.

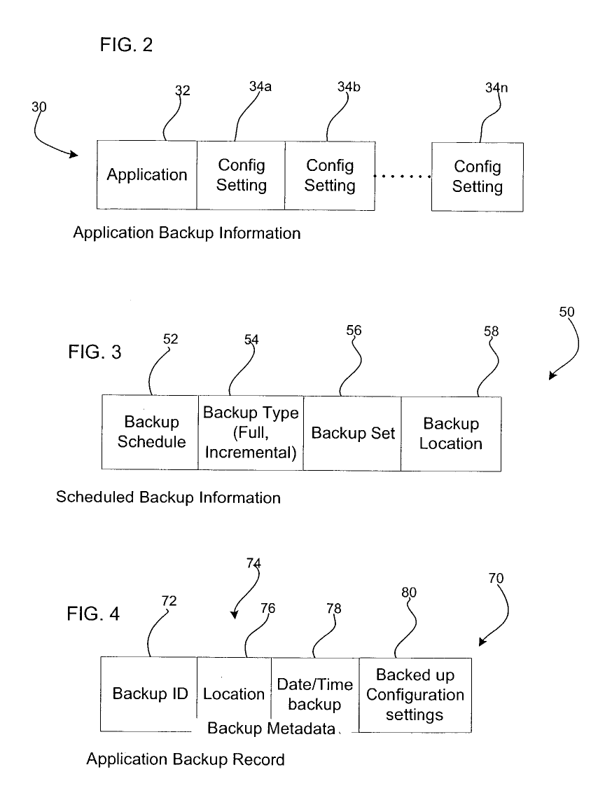

FIGS. 2, 3, and 4 illustrate information maintained in the configuration database 12 for use by the backup utility 10. FIG. 2 illustrates application backup information 30 that provides information on configuration settings 6a, 6b . . . 6n to backup for one application 4a, 4b . . . 4n. The application backup information 30 indicates an application 32, such as applications 4a, 4b . . . 4n, whose configuration settings are available for backup and one or more configuration setting 34a, 34b . . . 34n to backup for the corresponding application 32. Each configuration setting 34a, 34b . . . 34n information identifies a particular configuration setting to backup for the application 32. The configuration settings 34a, 34b . . . 34n may indicate a particular file including configuration settings or entries in a registry file providing configuration settings for an application, such as keys and values in the registry. The configuration database 12 may include multiple instances of the application backup 30 information, one instance for each application to backup.

FIG. 3 illustrates scheduled backup information 50 maintained in the configuration database 12 including information on a scheduled backup of configuration settings. The scheduled backup information 50 includes a backup schedule 52 providing information on a date, time and frequency of when to perform a configuration backup; a backup type 54 indicating a backup type such as a full backup of all data or an incremental backup of only those configurations settings that have changed since the last backup operation; a backup set 56 indicating the applications 4a, 4b . . . 4n and configuration settings 6a, 6b . . . 6n to backup; and a backup location 58 indicating one or more storage devices on which to store the configuration settings. Additionally, the backup location 58 may indicate local storage of the computer 2 to store the backup archive file 16, such as a partition.

In certain implementations, a system delivered with multiple installed applications 4a, 4b . . . 4n may include the backup utility 10 and a configuration database 12 including application backup 30 information for each reinstalled application 4a, 4b . . . 4n. As the user adds applications to the computer 2, the user may manually edit the configuration database 12 through a graphical user interface or command line to add application backup 30 information for subsequently installed programs or remove the application backup 30 information for any removed programs.

Further, the user may add scheduled backup information 50 for different backups to perform. Each scheduled backup 50 may backup different configuration settings 6a, 6b . . . 6n for different applications 4a, 4b . . . 4n. For instance, the configuration settings 6a, 6b . . . 6n for certain applications 4a, 4b . . . 4n that are used frequently may be included in a scheduled backup 50 that occurs during frequent intervals, such as daily, weekly, etc., whereas another scheduled backup 50 that is scheduled to occur less frequently may backup the configuration settings 6a, 6b . . . 6n of those applications 4a, 4b . . . n that are less frequently used and whose settings less frequently change.

FIG. 4 illustrates an example of a backup record 70 that is created by the backup utility 10 to backup configuration settings 6a, 6b . . . 6n as part of a scheduled backup. Each backup record 70 includes a backup identifier (ID) providing a unique identifier 72 of the backed up configuration settings; backup metadata 74 providing information on the backed up configurations settings 6a, 6b . . . 6n, such as the application 4a, 4b . . . 4n to which the setting applies. The backup metadata 74 includes location information 76 indicating the location on the computer 2 from which the settings were extracted. For instance, if the backed-up configuration settings 6a, 6b . . . 6n are included in a particular file, then the location information 76 will indicate the directory and file name for the configuration setting file. If the backed-up configuration settings 6a, 6b . . . 6n are parameters extracted from a file, such as a registry file, then the location information 76 would include the name of the file from which the settings are to be extracted, and the index and key the backed-up setting in the registry file. Timestamp information 78 indicates a date and time when the configuration setting was backed-up. The backed-up configuration settings 80 provide the actual backed up settings, which may comprise a specific file or particular configuration parameters, e.g., index, key, value, etc., if the settings were extracted from a file, such as registry file.

The application backup records 70 generated as part of a scheduled backup may be stored in single archive file 16 (FIG. 1), such as a Java Archive File (JAR), or any other archive file known in the art in which both files and data are stored, as well as metadata on the archived files and/or data. There may be a separate application backup record 70 for each separate configuration setting for an application, or multiple configuration settings and the metadata therefor may be stored within a single record or data structure. Further, application backup records 70 may provide different versions of backed-up configuration settings 80 for on application 4a, 4b . . . 4n generated at different times, as indicated and distinguished by the timestamp 78 information.

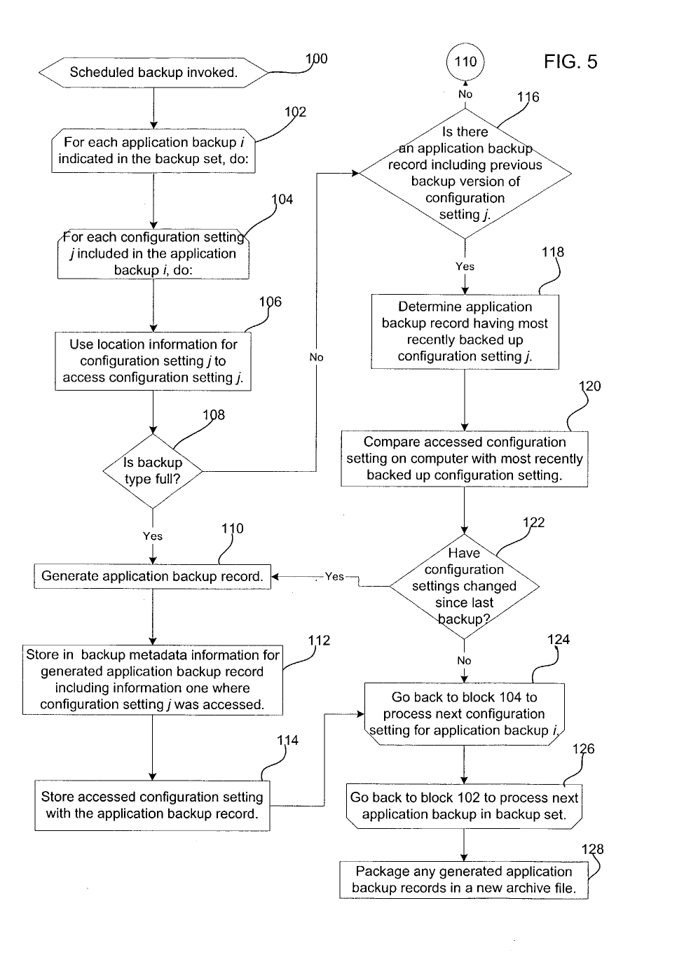

FIG. 5 illustrates operations performed by the backup utility 10 to backup configuration settings 6a, 6b . . . 6n in accordance with implementations of the invention. Upon invoking (at block 100) a scheduled backup 50 (FIG. 3), the backup utility 10 performs a loop at blocks 102 through 126 for each application backup 30 (FIG. 2) included in the backup set 56 of the scheduled backup 50 being invoked. For each application backup i to process, the backup utility 10 further performs a nested loop at blocks 104 through 124 for each configuration setting j (34a, 34b . . . 34n) included in application backup i. The backup utility 10 uses (at block 106) the location information for configuration setting j to access configuration setting j, which may comprise a file or parameters within a file, such as values within a registry file. If (at block 108) the backup type 54 (FIG. 3) of the invoked scheduled backup 50 is for a full backup, then the backup utility 10 generates (at block 110) an application backup record 70 (FIG. 4) and stores (at block 112) in backup metadata information 74 for the generated application backup record 70 the location 76 in the computer 2, i.e., file, location in file, etc., from where configuration setting j was accessed. The accessed configuration setting j is then stored (at block 114) as backed-up configuration setting 80 in the application backup record 70.

If (at block 108) the backup type 54 (FIG. 3) is incremental and if (at block 116) there is not a previous version of the configuration setting j already backed-up in a previously generated application backup record 70 (FIG. 4) in a previously saved backup archive file 16, then control proceeds to block 110 to generate the application backup record 70 for the accessed configuration setting j. Otherwise, if (at block 116) there is an application backup record 70 including a previous backup version of configuration setting j, then the backup utility 10 determines (at block 118) an application backup record 70 in the backup archive 16 having the most recent version of the configuration setting j. The backup utility may determine whether a previously backed up application backup record 70 in a previously generated backup archive file 16 has a previous version of the configuration setting j from some database or data structure, such as configuration database 12, that provides information on the content of previously backed-up archive files 16. Alternatively, the content of previous backed-up archive files 16 may be determined by reading metadata included in the archive files 16, such as the backup metadata 74 (FIG. 4).

The backup utility 10 then compares (at block 120) the previous version of the configuration setting j in the accessed application backup record 70 with the content of configuration setting j to determine (at block 122) whether the configuration settings j have changed since the last backup. This comparison may involve comparing a checksum value of the configuration settings j, comparing metadata or any other comparison technique known in the art. If the configuration settings i have changed, then control proceeds to block 110 to save the configuration setting j and generate a corresponding application backup record 70. If (at block 122) the configuration settings j have not changed, then the setting j is not backed-up because at block 122 the backup type is incremental, which means that only changed data is backed-up. After generating an application backup record 70 for the backed up configuration setting j 80 at block 114 or deciding not to backup the configuration setting j in an incremental backup at block 122, control proceeds (at block 126) back to block 104 to consider the next configuration setting 34a, 34b . . . 34n in the accessed application backup 30 (FIG. 2) for one application 4a, 4b . . . 4n. After processing all configuration settings 34a, 34b . . . 34n for one application in an application backup 30, control proceeds (at block 126) back to block 102 to process the next application backup 30 identified in the backup set 56 for the scheduled backup 50 (FIG. 3) being processed. After processing all the application backups 30 identified in the backup set 56, the backup utility 10 packages (at block 128) all the application backup records 70 in a backup archive file 16. The backup utility 10 may further include metadata in the archive file 16 including information on the backup performed in FIG. 5.

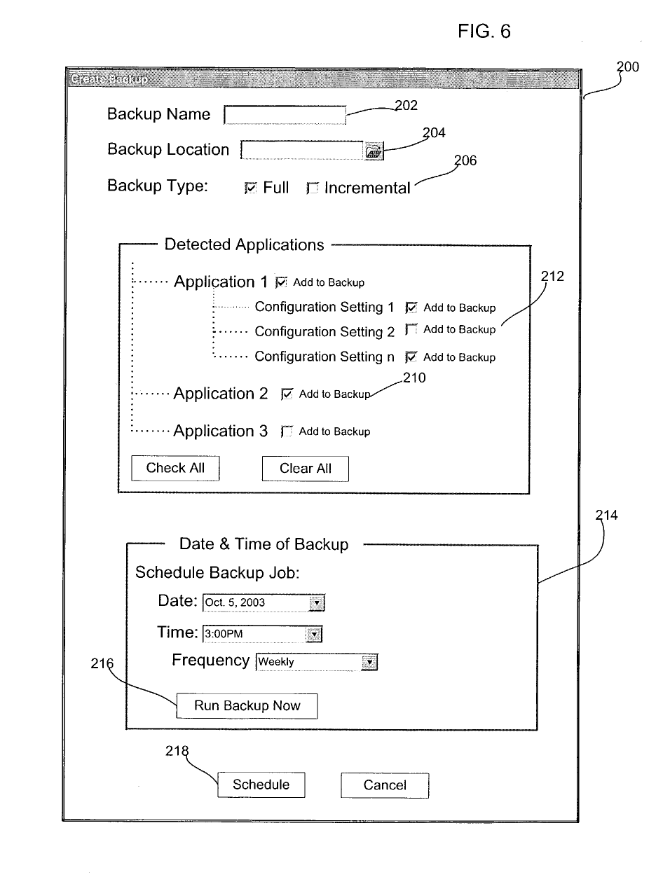

FIG. 6 illustrates an example of a graphical user interface (GUI) panel 200 displayed to enable a user to create a scheduled backup 50 (FIG. 3). The user may enter the name for the archive file that will include the backed-up configuration settings in name field 202, a location to store the generated archive file 16 in location field 204, which may comprise storage 14 or a local storage partition, and specify the type of backup by selecting one of the backup type check boxes 206 indicating an incremental or full backup, or any other backup type known in the art, such as differential backup. A detected applications section 208 displays all known installed applications 4a, 4b . . . 4n in the computer 2. These applications 4a, 4b . . . 4n may be detected from a registry file or other database identifying all installed applications 4a, 4b . . . 4n, or manually entered via another GUI panel (not shown). The user would select an application checkbox 210 to include all the configuration settings 6a, 6b . . . 6n for the selected application 4a, 4b . . . 4n into the scheduled backup. Additionally, the user can expand the listed application to display all the configuration settings for one application, which may display all files including configuration settings or values in a particular file. The user then can select one or more of the specific configuration settings for an application 4a, 4b . . . 4n by selecting the corresponding configuration setting check boxes 212. The user may also collapse the displayed configuration settings for a displayed application by further clicking or selecting the listed application name. The user may further specify the date, time and frequency for the scheduled backup in a date and time section 214 of the GUI panel 200. The user can select to immediately run the backup by selecting the “Now” button 216 or select the “Schedule” button 218 to cause the backup utility 10 to process the generated scheduled backup 50 according to the user selected schedule.

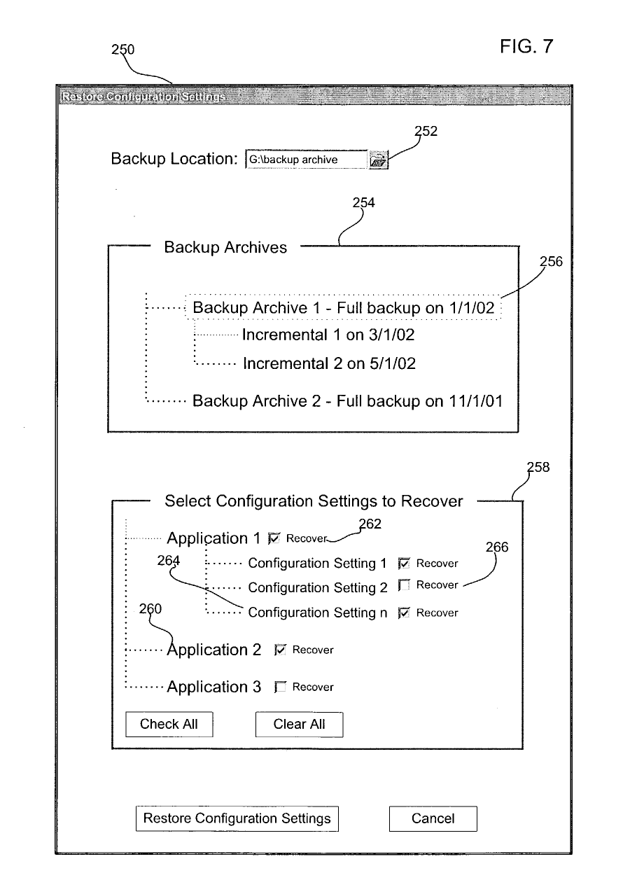

FIG. 7 illustrates a GUI panel 250 through which the user may select a previously generated archive file 16 from which configuration settings would be restored. The user may select a storage location in the backup location field 252 where backup archive files 16 are located. Upon selecting a storage location, such as file directory, having backup archive files 16, the backup utility 10 would list information on all the backup archive files 16 stored at the selected storage location in the backup archives section 254. The backup archive section 254 shows the name and time of each back-up archive file 16 and indicates whether the particular file is for an incremental or full backup. Incremental backups are displayed as associated with the full backup type of which they are a part. When the user selects one of the archive files, such as shown with the displayed backup archive 256, all the applications whose configuration settings are backed-up in the selected archive file 16 are listed in a select configuration settings section 258 of the GUI panel 250. The user may select to recover all the configuration settings for a listed application program by selecting the application recover check box 260. Further, the user may expand a listed application program 262 to list all the separately backed-up configuration settings for the application that may be separately recovered. The user may then select specific configuration settings for an application to recover by selecting specific configuration recover check boxes 266.

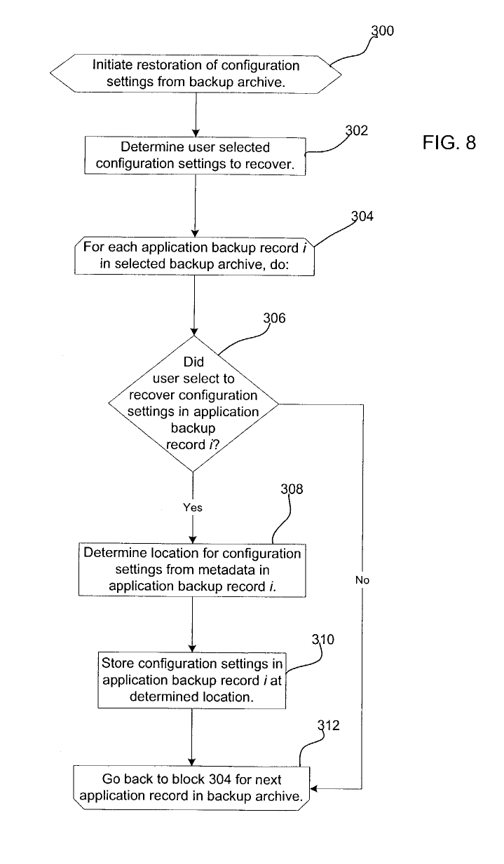

FIG. 8 illustrates operations performed by the backup utility 10 to recover configuration settings in accordance with implementations of the invention. Control begins at block 300 with a user invoking the backup utility 10 to restore configuration settings from a selected backup archive file 16, where the user may select the backup archive files and specific configurations settings stored therein through the restore configuration settings GUI panel 250 (FIG. 7). The user may invoke the backup utility 10 to recover configuration settings from a backup archive file 16 after reinstalling one or more applications 4a, 4b . . . 4n onto the computer 2. As mentioned, the user may recover configuration settings for all application programs after a hard drive or other failure that requires that the user reinstall all application programs due to a system failure. Additionally, the user may recover configuration settings for a selected application after reinstalling a single application. Still further, a system administrator may use the recover operation after cloning multiple systems with the same applications, and then using the backup utility 10 to apply the same settings to all the cloned systems.

The backup utility 10 would determine (at block 302) the user selected configuration settings from the selected backup archive file 16 to apply, which may be selected through the select configuration settings region 258 of the GUI panel 250 (FIG. 7). The backup utility 10 performs a loop at blocks 304-312 for each application backup record i 70 (FIG. 4) included in the selected backup archive file 16. If (at block 306) the user selected to recover the configuration settings 80 in the application backup record i, then the backup utility 10 determines (at block 308) the location on the computer system 2 for the backed-up configuration settings 80 from the location 76 metadata in the application backup record i. The backup utility 10 then stores (at block 310) the backed-up configuration settings 80 in the computer 2 at the location indicated in the location metadata 76. In alternative implementations, the user may be given an opportunity to select an alternate location at which to store the backed-up configuration settings 80. After writing the backed-up configuration to the computer system 2, overwriting any previously placed settings, control proceeds (at block 312) back to block 304 to process the next application backup record in the selected backup archive file 16.

With the described implementations, a user or system administrator may select applications and configuration settings to backup in an archive file. The user or administrator may recover one or more of previously backed up configuration settings in the event the user needs to reinstall the settings, such as the case when the user reinstalls one or more application programs on a computer. Additionally, a system administrator that has cloned applications onto multiple instances of a same computer system may apply configuration settings maintained in a backup archive file to all computers being cloned to allow the administrator to automatically apply the same configuration settings to all cloned systems.

The described techniques for backing-up and recovering application configuration settings may be implemented as a method, apparatus or article of manufacture using standard programming and/or engineering techniques to produce software, firmware, hardware, or any combination thereof. The term “article of manufacture” as used herein refers to code or logic implemented in hardware logic (e.g., an integrated circuit chip, Programmable Gate Array (PGA), Application Specific Integrated Circuit (ASIC), etc.) or a computer readable medium, such as magnetic storage medium (e.g., hard disk drives, floppy disks, tape, etc.), optical storage (CD-ROMs, optical disks, etc.), volatile and non-volatile memory devices (e.g., EEPROMs, ROMs, PROMs, RAMs, DRAMs, SRAMs, firmware, programmable logic, etc.). Code in the computer readable medium is accessed and executed by a processor. The code in which described embodiments are implemented may further be accessible through a transmission media or from a file server over a network. In such cases, the article of manufacture in which the code is implemented may comprise a transmission media, such as a network transmission line, wireless transmission media, signals propagating through space, radio waves, infrared signals, etc. Thus, the “article of manufacture” may comprise the medium in which the code is embodied. Additionally, the “article of manufacture” may comprise a combination of hardware and software components in which the code is embodied, processed, and executed. Of course, those skilled in the art will recognize that many modifications may be made to this configuration without departing from the scope of the present invention, and that the article of manufacture may comprise any information bearing medium known in the art.

In described implementations, information is described as being maintained in a particular format within various data structures, such as those shown in FIGS. 2, 3, and 4, in the configuration database. In alternative implementations, the information described may be stored in data structures having a different arrangement, and more or less data, than the data structures described with respect to with respect to FIGS. 2, 3, and 4. Further, the configuration database 12 may comprise a single database file including records, or may comprise multiple files including the information described with respect to FIGS. 2 and 3. Further, the application backup record may be in a different format than shown in FIG. 4.

In the described implementations, configuration settings backed-up as part of a scheduled backup operation are stored in a single archive file. In alternative implementations, the backed-up configuration settings may be stored in multiple files or data structures.

In the described implementations, the backup utility 10 would execute a scheduled backup when the time for the backup came due. In certain implementations, the backup utility 10 may spawn a separate daemon to monitor each different backup operation.

The backup utility 10 may include additional functionality, such as including the capability to delete backup archive files 16 according to some criteria, such as the age of the archive.

The described implementations discussed a full and incremental backup, where an incremental backup involves at each backup, backing up the files that have changed since the last backup, which may be changes over the full backup (for the first incremental backup) or a previous incremental backup (for any incremental backup following the first incremental backup). In further implementations, the backup utility 10 may allow for a differential backup which maintains only one differential backup file having all configuration setting changes since the initial full backup.

The illustrated logic of FIG. 5 and 8 show certain events occurring in a certain order. In alternative implementations, certain of the described operations may be performed in a different order, modified or removed. Morever, steps may be added to the above described logic and still conform to the described implementations. Further, operations described herein may occur sequentially or certain operations may be processed in parallel. Yet further, operations may be performed by a single processing unit or by distributed processing units.

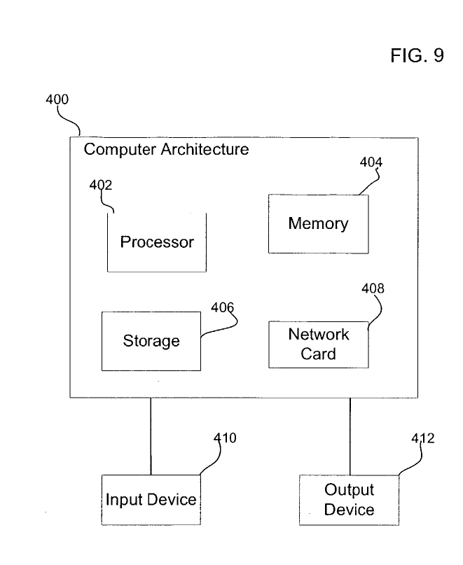

FIG. 9 illustrates one implementation of a computer architecture 400 of the components and systems shown in FIGS. 1 and 3. The architecture 400 may include a processor 402 (e.g., a microprocessor), a memory 404 (e.g., a volatile memory device), and storage 406 (e.g., a non-volatile storage, such as magnetic disk drives, optical disk drives, a tape drive, etc.). The storage 406 may comprise an internal storage device or an attached or network accessible storage. Programs in the storage 406 are loaded into the memory 404 and executed by the processor 402 in a manner known in the art. The architecture further includes a network card 408 to enable communication with a network. An input device 410 is used to provide user input to the processor 402, and may include a keyboard, mouse, pen-stylus, microphone, touch sensitive display screen, or any other activation or input mechanism known in the art. An output device 412 is capable of rendering information transmitted from the processor 402, or other component, such as a display monitor, printer, storage, etc.

The foregoing description of various implementations of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. A method for maintaining configuration settings for applications on a computer system, comprising:
maintaining configuration backup information indicating configuration settings to backup for at least one application;
processing the configuration backup information to access the indicated configuration settings for the at least one application on the computer system to backup;
storing the accessed configuration settings for the at least one application in at least one file; and
recovering the stored configuration settings for use with the at least one application.

2. The method of claim 1, further comprising:
receiving user selection of the at least one application and at least one configuration setting for the selected at least one application to include in the configuration backup information.

3. The method of claim 2, further comprising:
determining applications installed on the computer; and
displaying in a user interface a list of all the determined applications, wherein the user selection of the at least one application is selected from the displayed list in the user interface.

4. The method of claim 3, wherein the applications are determined from a registry listing all installed applications on the computer.

5. The method of claim 2, further comprising:
receiving user selection of a scheduled time to include with the configuration backup information, wherein the configuration backup information is processed at the scheduled time.

6. The method of claim 2, wherein the user selection selects less than all the configuration settings for one application program to include with the configuration backup information.

7. The method of claim 1, wherein the configuration backup information is part of a scheduled backup, further comprising:
determining whether the scheduled backup is for an incremental backup type; and
if the scheduled backup is for the incremental backup type, then determining whether each indicated configuration setting in the configuration backup information has changed since a most recent backup of the configuration setting, wherein the indicated configuration setting is only accessed and stored if the indicated configuration setting has changed.

8. The method of claim 1, wherein the configuration backup information indicates a backup location, further comprising:
storing the at least one file including the stored configurations settings in the indicated backup location.

9. The method of claim 8, wherein the indicated backup location comprises a removable storage medium.

10. The method of claim 1, wherein recovering the stored configuration settings further comprises:
receiving user selection of a subset of the stored configuration settings to recover;
accessing the user selected subset of the stored configuration settings; and
writing the selected subset of configuration settings to the computer to use with the applications associated with the configuration settings.

11. The method of claim 1, wherein a plurality of archive files include stored configuration settings that were generated at different times.

12. The method of claim 11, wherein a plurality of scheduled backups include configuration backup information that indicates different configuration settings for different application programs, wherein the archive files include configuration settings backed-up during the processing of the scheduled backups, and wherein recovering the stored configuration settings further comprises:
receiving user selection of one of the archive files, wherein the stored configuration settings written to the computer are recovered from the selected archive file.

13. The method of claim 12, further comprising:
displaying a list of applications in a user interface whose configuration settings are stored in the selected archive file;
displaying the configuration settings in the selected archive file for at least one of the listed applications in the user interface; and
displaying selection indicators to enable user selection of specific configuration settings to recover, wherein only the user selected configuration settings are recovered from the archive file.

14. The method of claim 1, further comprising:
storing with each stored configuration setting a location in the computer system indicating from where the configuration setting was accessed.

15. The method of claim 14, wherein recovering the stored configuration settings further comprises:
for each stored configuration setting to recover, determining the location in the computer system from where the configuration setting was accessed; and
writing stored configuration settings to the determined locations in the computer system.

16. The method of claim 1, wherein the stored configuration settings are recovered to a plurality of computer systems that include the application programs that use the stored configuration settings.

17. A system for maintaining configuration settings, comprising:
a computer system;
an application installed on the computer system;
means for maintaining configuration backup information indicating configuration settings to backup for at least one application;
means for processing the configuration backup information to access the indicated configuration settings for the at least one application on the computer system to backup;
means for storing the accessed configuration settings for the at least one application in at least one file; and
means for recovering the stored configuration settings for use with the at least one application.

18. The system of claim 17, further comprising:
means for receiving user selection of the at least one application and at least one configuration setting for the selected at least one application to include in the configuration backup information.

19. The system of claim 18, wherein the user selection selects less than all the configuration settings for one application program to include with the configuration backup information.

20. The system of claim 17, wherein the configuration backup information is part of a scheduled backup, further comprising:
means for determining whether the scheduled backup is for an incremental backup type; and
means for determining, if the scheduled backup is for the incremental backup type, whether each indicated configuration setting in the configuration backup information has changed since a most recent backup of the configuration setting, wherein the indicated configuration setting is only accessed and stored if the indicated configuration setting has changed.

21. The system of claim 17, wherein the configuration backup information indicates a backup location, further comprising:
means for storing the at least one file including the stored configurations settings in the indicated backup location.

22. The system of claim 17, wherein recovering the stored configuration settings further comprises:
means for receiving user selection of a subset of the stored configuration settings to recover;
means for accessing the user selected subset of the stored configuration settings; and
means for writing the selected subset of configuration settings to the computer to use with the applications associated with the configuration settings.

23. The system of claim 17, further comprising:
means for storing with each stored configuration setting a location in the computer system indicating from where the configuration setting was accessed.

24. The system of claim 23, wherein the means for recovering the stored configuration settings further performs:
for each stored configuration setting to recover, determining the location in the computer system from where the configuration setting was accessed; and
writing stored configuration settings to the determined locations in the computer system.

25. An article of manufacture for maintaining configuration settings for applications on a computer system, wherein the article of manufacture causes operations to be performed, the operations comprising:
maintaining configuration backup information indicating configuration settings to backup for at least one application;
processing the configuration backup information to access the indicated configuration settings for the at least one application on the computer system to backup;
storing the accessed configuration settings for the at least one application in at least one file; and
recovering the stored configuration settings for use with the at least one application.

26. The article of manufacture of claim 25, further comprising:
receiving user selection of the at least one application and at least one configuration setting for the selected at least one application to include in the configuration backup information.

27. The article of manufacture of claim 26, further comprising:
determining applications installed on the computer; and
displaying in a user interface a list of all the determined applications, wherein the user selection of the at least one application is selected from the displayed list in the user interface.

28. The article of manufacture of claim 27, wherein the applications are determined from a registry listing all installed applications on the computer.

29. The article of manufacture of claim 28, further comprising:
receiving user selection of a scheduled time to include with the configuration backup information, wherein the configuration backup information is processed at the scheduled time.

30. The article of manufacture of claim 26, wherein the user selection selects less than all the configuration settings for one application program to include with the configuration backup information.

31. The article of manufacture of claim 25, wherein the configuration backup information is part of a scheduled backup, further comprising:
determining whether the scheduled backup is for an incremental backup type; and
if the scheduled backup is for the incremental backup type, then determining whether each indicated configuration setting in the configuration backup information has changed since a most recent backup of the configuration setting, wherein the indicated configuration setting is only accessed and stored if the indicated configuration setting has changed.

32. The article of manufacture of claim 25, wherein the configuration backup information indicates a backup location, further comprising:
storing the at least one file including the stored configurations settings in the indicated backup location.

33. The article of manufacture of claim 32, wherein the indicated backup location comprises a removable storage medium.

34. The article of manufacture of claim 25, wherein recovering the stored configuration settings further comprises:
receiving user selection of a subset of the stored configuration settings to recover;
accessing the user selected subset of the stored configuration settings; and
writing the selected subset of configuration settings to the computer to use with the applications associated with the configuration settings.

35. The article of manufacture of claim 25, wherein a plurality of archive files include stored configuration settings that were generated at different times.

36. The article of manufacture of claim 35, wherein a plurality of scheduled backups include configuration backup information that indicates different configuration settings for different application programs, wherein the archive files include configuration settings backed-up during the processing of the scheduled backups, and wherein recovering the stored configuration settings further comprises:
receiving user selection of one of the archive files, wherein the stored configuration settings written to the computer are recovered from the selected archive file.

37. The article of manufacture of claim 36, further comprising:
displaying a list of applications in a user interface whose configuration settings are stored in the selected archive file;
displaying the configuration settings in the selected archive file for at least one of the listed applications in the user interface; and
displaying selection indicators to enable user selection of specific configuration settings to recover, wherein only the user selected configuration settings are recovered from the archive file.

38. The article of manufacture of claim 25, further comprising:
storing with each stored configuration setting a location in the computer system indicating from where the configuration setting was accessed.

39. The article of manufacture of claim 38, wherein recovering the stored configuration settings further comprises:
for each stored configuration setting to recover, determining the location in the computer system from where the configuration setting was accessed; and
writing stored configuration settings to the determined locations in the computer system.

40. The article of manufacture of claim 25, wherein the stored configuration settings are recovered to a plurality of computer systems that include the application programs that use the stored configuration settings.
